(19) United States
(12) Patent Application Publication
(10) Pub. No.: US 2002/0083196 A1
(43) Pub. Date: Jun. 27, 2002

(54) Generating responses in EDI systems

(76) Inventor: David Moyers, Columbia, TN (US)

Correspondence Address: William T. Ellis, FOLEY & LARDNER, Washington Harbour, 3000 K Street, N.W., Suite 500, Washington, DC, 20007-5109, US

(21) Appl. No.: 09/748,134

(22) Filed: Dec. 27, 2000

(51) Int. Cl. G06F 15/173

(52) U.S. Cl. 709/238

(57) ABSTRACT

A business-to-business electronic commerce system receives inbound documents. As part of the step of sending to an addressee's mailbox, the system automatically determines candidate reply transaction documents appropriate and available to each inbound document. A HTML link is displayed for each available reply next to inbound document header data. Upon clicking of a selected reply from the candidate set the system automatically populates the selected reply document and prompts a user to complete.

### BACKGROUND OF THE INVENTION

The invention relates to generation of responses to inbound EDI documents.

A good deal of automation has been introduced for business-to-business electronic commerce systems using communication mechanisms such as EDI. However, in light of the fact that many users of such systems are required to perform a larger volume of transactions in any one working period, there is a requirement to introduce a greater deal of automation and reduce human interfacing time for performing transactions.

The invention addresses this need.

### SUMMARY OF THE INVENTION

According to the invention, there is provided a method of processing an inbound transaction document sent by a trading partner to a user in an electronic commerce system, the method comprising the steps of:

receiving the inbound document at an interface for communication with trading partners;

routing the inbound document to a mailbox of the user;

automatically determining a set of candidate reply transaction documents associated with the inbound document;

displaying a link to each candidate reply transaction document of said set adjacent to a header of the inbound document in a screen of a mailbox application for the user;

receiving a user selection of a reply transaction document from said candidate set;

parsing the inbound document to determine transaction data relevant to the selected reply document;

automatically populating the selected reply document with said transaction data;

generating a user edit screen displaying the automatically-populated selected transaction reply document, receiving a user input of additional transaction data, and writing said additional data to the reply document; and

transmitting the reply document.

In one embodiment, the system determines the set of candidate reply transaction documents by performing a look-up to a database indexed with the inbound document sender and addressee and the inbound document type.

In another embodiment, the system determines the set of candidate reply transaction documents by operation of a translation engine:

checking the inbound documents for compliance with a standard model,

sending a negative functional acknowledgement to the trading partner or rejecting the inbound document if the compliance check is negative.

In a one embodiment, the inbound document is parsed by a translation engine of the system translating the inbound document into a pre-populated selected reply document.

In another embodiment, the translation engine writes the pre-populated selected reply document to a set of data structures in memory, and a mail engine of the system creates a pre-populated HTML reply document for rendering within a browser.

In one embodiment, the additional data is inputted to the system with use of a tool for appending data to fields.

In another embodiment, the additional data is inputted to the system with use of a tool for replacing automatically populated data.

According to another aspect, the invention provides an electronic commerce system comprising means for performing a method as set out above.

### BRIEF DESCRIPTION OF THE DRAWINGS

The invention will be more clearly understood from the following description of some embodiments thereof, given by way of example only with reference to the accompanying drawings in which:

FIGS. 1(a) and 1(b) are together a flow diagram illustrating initialisation and real time document processing operations;

FIG. 2 is a screen shot for an EDI document mailbox; and

FIG. 3 is a screen shot illustrating a document generated by the system, in response to user interaction at the mailbox.

### DETAILED DESCRIPTION OF THE INVENTION

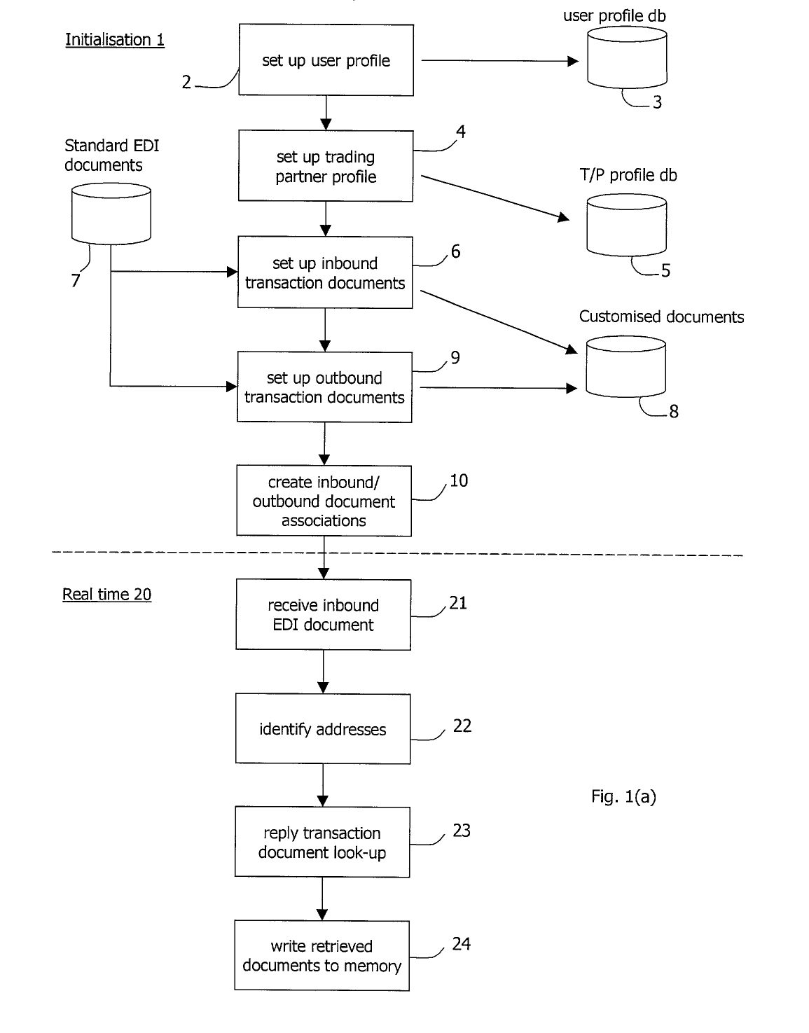

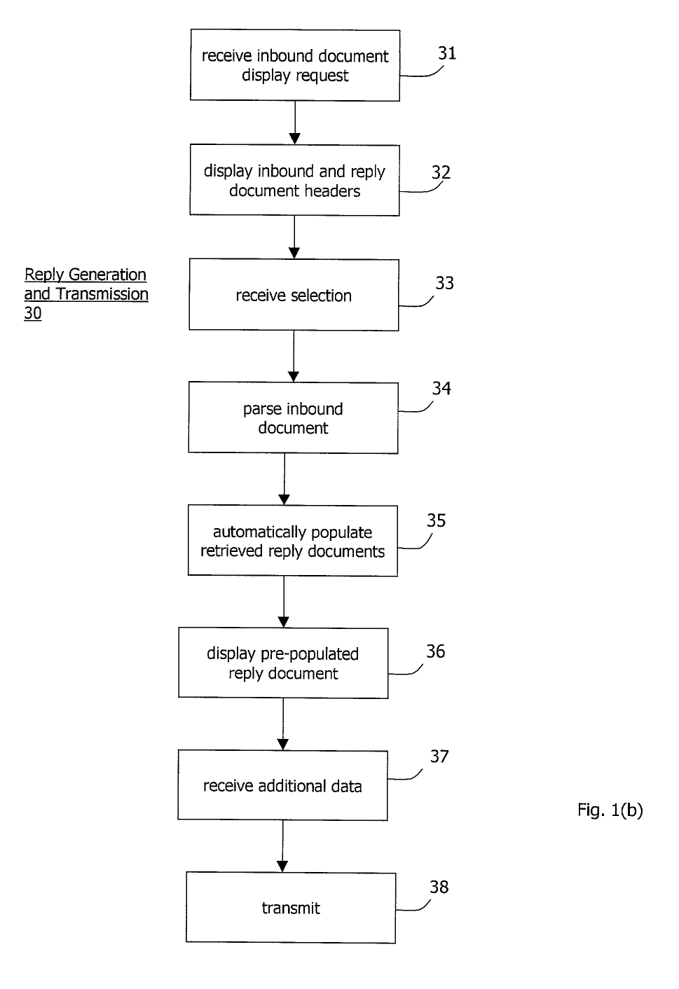

Referring to FIGS. 1(a) and 1(b) an initialisation process 1 and a real time document processing process 20 are described. These processes are carried out by an EDI business-to-business automation system to reduce the extent of paperwork for conducting business, allow for transactions to be processed more speedily, and to make communication between trading partners more effective.

In a step 2 of the initialisation process 1, the system sets up a user profile in a database 3. This includes:

User logon ID

Password

EDI Address

Company Information

Company Name

Address

City/Town

State/Province

Postal Code

Country

Contact Information

Contact First / Last Name

Contact Address Information (same items as for Company Information)

Phone Number / Phone Extension

Fax Number

E-mail Address

Billing Information

Billing Address Information (same items as for Company Information)

Billing Subscription Type (i.e. Subscription Option (e.g. Monthly, Annually, Pay As You Go)).

A setting (on/off) for automatic e-mail notification of documents received into mailbox. (By default, users are e-mailed when documents arrive in their mailbox. They have the ability to turn this feature off).

Customised features such as custom folders and options for back-office integration.

A trading partner (T/P) profile is set up in step 4 in a database 5. This includes:

EDI Address of the Trading Partner (TP)

Company Information (as listed above)

Contact Information (as listed above)

EDI Transaction set information indicating the mandatory transaction sets that are to be traded between the partners.

Trading relationship information that defines the limits of electronic trading between the partners (for example, “I can only send an Invoice to a trading partner, but I can not send a Purchase Order to the trading partner”).

In step 6, the system sets up inbound transaction documents, by either selecting from a database 7 of standard documents or by manually inputting text for new documents. Customised documents are saved to a database 8.

Outbound documents (from the user's perspective) are set up in page 9. Again standard documents may be chosen or new ones created.

In step 10, the user then inputs to the system association of an outbound document for reply to each inbound document. These associations are indexed on the user profile ID and the trading partner profile ID. User profile and relationship data is audited and backed up.

The real time process 20 is initiated with a step 21 in which an inbound document is received from one of the trading partners for which there is a profile stored in the database 5. The sender and receiver addresses we identified in step 22 and are used in step 23 to perform a reply document look-up in the databases 5 and 8. This look-up retrieves a list of the outbound reply transaction documents associated with the received inbound document. These documents are written to memory in step 24.

In more detail, the inbound document's interchange envelope is parsed to determine the type of EDI standard (protocol) that is used (e.g. ANSI, EDIFACT, or TRADACOMS). After this determination, the system sends an appropriate “standard model” and the inbound document to a compliance check function of a translation engine. A standard model is used to denote how a standard is syntactically formatted/delimited, and contains the accepted code lists for elements within the transaction set.

The system uses the engine to compliance check the inbound document. If not compliant, the system will either send a negative functional acknowledgement back to the sending trading partner or completely reject the interchange. Which of these are done is specific to the EDI standard (protocol).

If the system is configured for automatic real time notification of the user the remaining steps are initiated automatically. However, the system may be configured for generation of a reply only when the user requests viewing of an “inbox”, as in the illustrated embodiment in step 31.

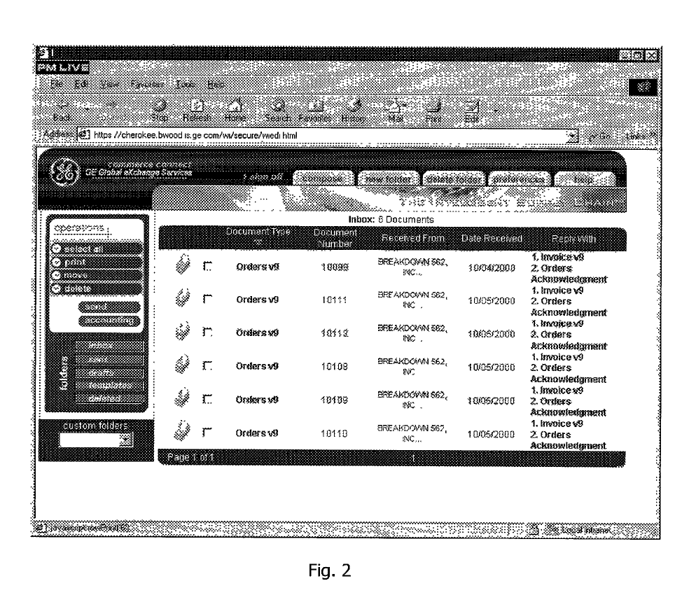

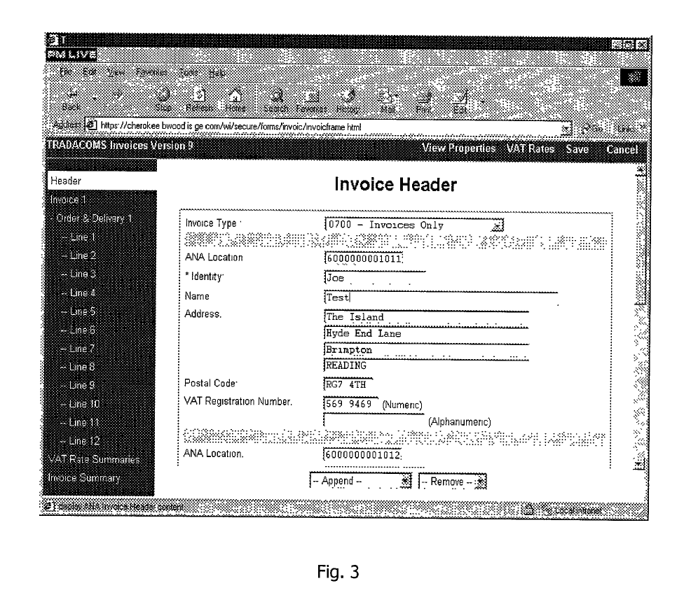

Referring also to FIGS. 2 and 3, in this embodiment the system in step 32 displays a set of six inbound document headers. All of the documents relate to orders, and there is a unique identifier for each document. The sender is also indicated, as is the date. However, in addition, the system also displays automatically the candidate transaction reply documents determined in steps 23 and 24 to be available and appropriate for replies to the inbound documents. A HTML option is displayed for every possible transaction in the transaction set, for every displayed inbound document. In this example, the options have a header “Reply With” and the set comprises:

“Orders Acknowledgement”, and

“Invoice”.

Thus, to generate a reply to an inbound document, the user only needs to click on the selected reply document in step 33. The system then invokes the translation engine, giving it the inbound document and a translation model. The translation model is used to instruct the translation engine how to translate the inbound document into the target reply document. These instructions explain what data is pertinent from the inbound document, together with any computational or conditional operations. The translation (indicated in step 34) involves parsing the inbound document. After the translation, the system loads the newly-created outbound document from disk into a set of data structures in memory.

A browser of the system then reads the data from the data structures and dynamically creates the pre-populated HTML document in step 35, and it is rendered within the user's browser in step 36. The end user may then change the contents of the document if necessary, and finally, send it to their trading partner.

An example reply document is shown in FIG. 3. This is pre-populated with data drawn from the source document, determined in the parsing step 34. The prepopulated data is in this example:

Invoice type,

user location,

trading partner name and address, and

user VAT Registration No.

In step 37 the data is amended/augmented with use of tools having “Append” and “Remove” icons. These functions allow for the addition / removal of data to/from the transaction reply. These functions are particularly useful when human intervention is necessary to make changes within a document based on consequences at that point in time (for example “I will bill the trading partner for all items except item X”. Examples of data that can be added or removed are:

Individual Line Items within a purchase order.

Data narratives (descriptions about aspects of line items or other data within the transaction set).

In the case of TRADACOMS EDI standards, addition or removal of an order within a set of orders.

The finalised reply document is transmitted in step 38.

It will be appreciated that the invention provides for a very large extent of automation, thus minimising human error and allowing transactions to be more quickly processed.

The invention thus provides the advantage of the user being presented with the appropriate available transaction set without the need to enter menus and manually “drill down” through a hierarchy. Only a single mouse or keyboard user input to select the transaction is required. Also, the document data is correct because it is selected by the system and so is not prone to human error.

The invention is not limited to the embodiments described but may alternatively be varied in construction and detail. The reply document may be automatically populated together with all documents of the candidate set before user selection.

What is claimed is:

1. A method of processing an inbound transaction document sent by a trading partner to a user in an electronic commerce system, the method comprising the steps of:
receiving the inbound document at an interface for communication with trading partners;
routing the inbound document to a mailbox of the user;
automatically determining a set of candidate reply transaction documents associated with the inbound document;
displaying a link to each candidate reply transaction document of said set adjacent to a header of the inbound document in a screen of a mailbox application for the user;
receiving a user selection of a reply transaction document from said candidate set;
parsing the inbound document to determine transaction data relevant to the selected reply document;
automatically populating the selected reply document with said transaction data;
generating a user edit screen displaying the automatically-populated selected transaction reply document, receiving a user input of additional transaction data, and writing said additional data to the reply document; and
transmitting the reply document.

2. A method as claimed in claim 1, wherein the system determines the set of candidate reply transaction documents by performing a look-up to a database indexed with the inbound document sender and addressee and the inbound document type.

3. A method as claimed in claim 1, wherein the system determines the set of candidate reply transaction documents by operation of a translation engine:
checking the inbound documents for compliance with a standard model,
sending a negative functional acknowledgement to the trading partner or rejecting the inbound document if the compliance check is negative.

4. A method as claimed in claim 1, wherein the inbound document is parsed by a translation engine of the system translating the inbound document into a prepopulated selected reply document.

5. A method as claimed in claim 4, wherein the translation engine writes the prepopulated selected reply document to a set of data structures in memory, and a mail engine of the system creates a pre-populated HTML reply document for rendering within a browser.

6. A method as claimed in claim 1, wherein the additional data is inputted to the system with use of a tool for appending data to fields.

7. A method as claimed in claim 1, wherein the additional data is inputted to the system with use of a tool for replacing automatically populated data.

8. An electronic commerce system comprising means for performing a method as claimed in claim 1.

9. A computer program product comprising software code for performing the steps of claim 1 when executing on a digital computer.
